(19) United States
(12) Patent Application Publication
(10) Pub. No.: US 2010/0172125 A1
(43) Pub. Date: Jul. 8, 2010

(54) LIGHT EMISSION DEVICE AND DISPLAY DEVICE USING THE SAME

(76) Inventor: Kyung-Sun Ryu, Suwon-si (KR)

Correspondence Address: CHRISTIE, PARKER & HALE, LLP, PO BOX 7068, PASADENA, CA, 91109-7068, US

(21) Appl. No.: 12/643,996

(22) Filed: Dec. 21, 2009

(30) Foreign Application Priority Data
Jan. 6, 2009 (KR) 10-2009-0000789

(51) Int. Cl. G09F 13/04; H01J 9/02; H01J 1/62; H01J 9/00

(52) U.S. Cl. 362/97.1; 313/310; 313/498; 445/23

(57) ABSTRACT

A light emitting device and a display device having the same, and the light emitting device according to an embodiment includes a substrate, a first electrode formed in a stripe pattern on the substrate, an electron emission region formed on the first electrode, and a second electrode formed in a stripe pattern along a direction that crosses the first electrode. The second electrode includes a supporting portion adhered to the substrate, and a mesh portion of which a surface that faces the first electrode is recessed to be separated from the first electrode and the electron emission region.

### CROSS-REFERENCE TO RELATED APPLICATION

This application claims priority to and the benefit of Korean Patent Application No. 10-2009-0000789, filed in the Korean Intellectual Property Office on Jan. 6, 2009, the entire content of which is incorporated herein by reference.

### BACKGROUND

1. Field

The following description relates generally to a light emitting device and a display device using the same.

2. Description of the Related Art

Light emitting devices that emit light include a light emitting device that uses a field emission mechanism. A light emitting device using a field emission mechanism can include a front substrate on which a phosphor layer and an anode electrode are formed, and a rear substrate on which electron emission regions and driving electrodes are formed. Here, edges of the front substrate and the rear substrate are integrally sealed by a sealing member and then an internal space is exhausted to form a vacuum chamber.

The driving electrodes include cathode electrodes and gate electrodes that are separately formed on the cathode electrodes and extending along a direction crossing the cathode electrodes. In addition, openings are formed in the gate electrodes at cross regions of the cathode electrodes and the gate electrodes, and electron emission regions are formed to be spatially separated from the gate electrodes and on the cathode electrodes. That is, the gate electrodes are insulated from the cathode electrodes and the electron emission regions.

In the above-described configuration, when a set or predetermined driving voltage is applied to one of the cathode electrodes and a corresponding gate electrode of the gate electrodes, an electric field is formed around a corresponding electron emission region in which a voltage difference between two electrodes is higher than a threshold value, and electrons are emitted from the corresponding electron emission region. The emitted electrons are attracted by the high voltage applied to the anode electrode so as to collide with and excite the corresponding phosphor layer, and accordingly the phosphor layer emits visible light.

As described, the disclosed light emitting device has a structure in which an insulation layer is formed between the cathode electrode and the gate electrode for insulation therebetween, or a groove is formed in the rear substrate and the cathode electrode and the electron emission region are formed inside the groove formed in the rear substrate.

However, light emitting devices having an insulation layer or a rear substrate with a groove formed therein may have a complicated manufacturing process, or an error may be generated during a manufacturing process. Specifically, a thin film process and a thick film process are repeated several times in order to form the insulation layer between the cathode and the gate electrode. In addition, a sand blast process or an etching process may be additionally performed to form the groove in the rear substrate, and it is difficult to form the cathode electrode and the electron emission region inside the groove.

The above information disclosed in this Background section is only for enhancement of understanding of the background of the described technology and therefore it may contain information that does not form the prior art that is already known in this country to a person of ordinary skill in the art.

### SUMMARY OF THE INVENTION

Aspects of embodiments of the present invention are directed toward a light emitting device having a stable and simplified structure so as to improve manufacturing productivity, and a display device using the same.

A light emitting device according to an exemplary embodiment includes a first substrate; a first electrode in a stripe pattern extending along a first direction and on the first substrate; an electron emission region on the first electrode; and a second electrode in a stripe pattern extending along a second direction crossing the first direction of the first electrode. Here, the second electrode includes a supporting portion adhered to the first substrate and a mesh portion having a surface facing the first electrode, the surface of the mesh portion being recessed away from the first electrode and the electron emission region.

The mesh portion may include a plurality of openings for transmitting an electron beam emitted from the electron emission region.

The light emitting device may further include a second substrate opposing the first substrate, and a third electrode and a phosphor layer formed on a surface of the second substrate and between the first substrate and the second substrate.

The second electrode may be formed of a metal plate having a greater average thickness than that of the first electrode.

The mesh portion may be formed through a double etching process or a double-sided etching process.

A display device according to another exemplary embodiment includes the above-described light emitting device and a display panel receiving light from the light emitting device and displaying an image.

### BRIEF DESCRIPTION OF THE DRAWINGS

FIG. 1 is a partially cut-away perspective view of a light emitting device according to an exemplary embodiment.

FIG. 2 is a partial cross-sectional view of the light emitting device of FIG. 1.

FIG. 3 is a schematic perspective view of a display device according to an exemplary embodiment.

FIG. 4 is a partial cross-sectional view of a display panel of FIG. 3.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

In addition, the size and the thickness of each element in the drawings are samples for better understanding and ease of description, and the present invention is not limited thereto.

In the drawings, the thickness of layers, films, panels, regions, etc., may be exaggerated for clarity, and/or for better understanding and ease of description. It will be understood that when an element such as a layer, film, region, or substrate is referred to as being “on” an other element, it can be directly on the other element or one or more intervening elements may also be present therebetween. In contrast, when an element is referred to as being “directly on” an other element, there are no intervening elements present between the element and the other element.

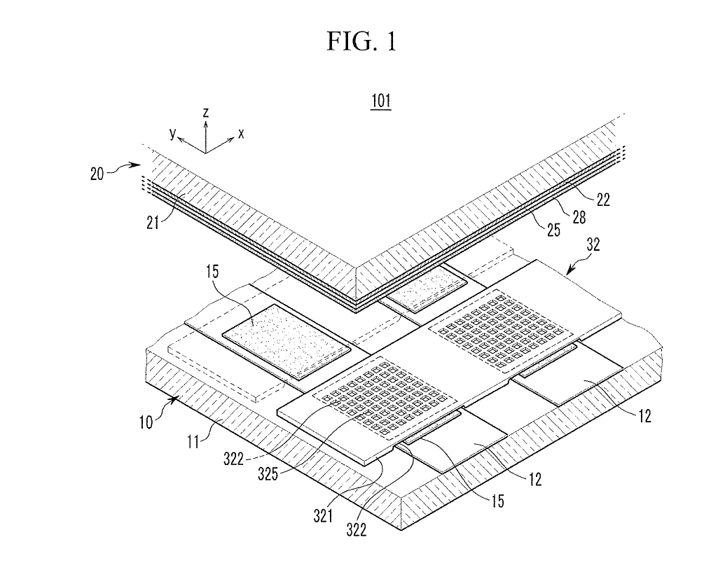

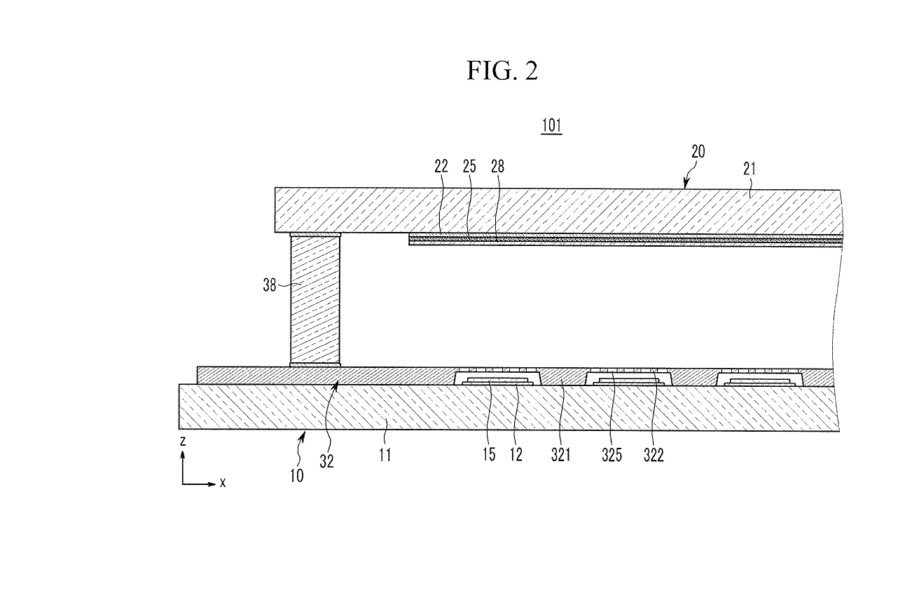

Hereinafter, a light emitting device 101 according to an exemplary embodiment will be described in more detail with reference to FIG. 1 and FIG. 2.

As shown in FIG. 1, the light emitting device 101 according to the exemplary embodiment includes a first substrate assembly 10, a second substrate assembly 20 that is arranged to oppose the first substrate assembly 10, and a sealing member 38 (see FIG. 2) that is interposed between the first and second substrate assemblies 10 and 20 to seal the two substrate assemblies 10 and 20 together. An internal space of the first substrate assembly 10, the second substrate assembly 20, and the sealing member 38 maintains a vacuum degree of approximately 10⁻⁶ Torr.

The first substrate assembly 10 includes a first substrate (e.g., a rear substrate) 11, a first electrode 12, an electron emission region 15, and a second electrode 32. Here, the first electrode 12 is a cathode electrode and the second electrode 32 is a gate electrode.

The first electrode 12 is formed in a stripe pattern on one side of the first substrate 11, along one direction (y axis direction). In addition, the first electrode 12 is formed through a thin film process.

The electron emission region 15 is formed on the first electrode 12. In FIG. 1, the electron emission region 15 is formed at a crossing area of the first and second electrodes 12 and 32, but an embodiment is not limited thereto. Therefore, the electron emission region 15 may be formed on the first electrode 12 in a stripe pattern parallel to the first electrode 12.

The electron emission region 15 includes materials that emit electrons when an electric field is applied in a vacuum condition, and the materials for example include a carbon-based material and/or a nanometer (nm)-sized material. For example, the electron emission region 15 may include a material selected from a group of carbon nanotubes, graphite, graphite nanofibers, diamond, diamond-like carbon, fullerene (C₆₀), silicon nanowires, and combinations thereof.

The electron emission region 15 may be formed as an electron emitting layer formed to have a set or predetermined thickness through a thick film process such as screen-printing. That is, the electron emission region 15 may be formed by performing screen-printing of a paste mixture that includes an electron emitting material on the first electrode 12, baking and firing the printed mixture, and then activating a surface of the electron emission region 15 to expose the electron emitting materials to the surface. The surface activation process may include attaching an adhesive tape and detaching the same. Through the surface activation process, the electron emitting materials such as carbon nanotubes can be raised substantially perpendicular to the surface of the electron emission region 15 while partially eliminating the surface of the electron emission region 15.

As described, the first electrode 12 and the electron emission region 15 are formed on a flat surface, thereby easing a manufacturing process.

The second electrode 32 is formed in a stripe pattern along a direction (x axis direction) that crosses the first electrode 12. In addition, the second electrode 32 includes a supporting portion 321 that is attached to an inner surface of the first substrate 11 and a mesh portion 322 of which a surface that faces the first electrode 12 at a crossing region of the first electrode 12 and the second electrode 12 is recessed to be separated from the first electrode 12 and the electron emission region 15. That is, a thickness of the difference between the supporting portion 321 and the mesh portion 322 of the second electrode 32 may be larger than a sum of the thickness of the first electrode 12 and the thickness of the electron emission region 15. In addition, the length of the portion of the second electrode 32 where the mesh portion 322 is formed is longer than the width of the first electrode 12. Therefore, by including the mesh portion 322, the second electrode 32 can be entirely and stably separated from the first electrode 12 and the electron emission region 15 formed on the first substrate 11. That is, the second electrode 32 is stably insulated from the first electrode 12 and the electron emission region 15. Here, the inner surface of the first substrate 11 refers to a surface that is disposed to face the second substrate assembly 20.

In addition, the mesh portion 322 has a plurality of openings 325 for passing an electron beam emitted from the electron emission region 15. That is, the mesh portion 322 is recessed along the length direction of the first electrode 12 so that the thickness thereof is relatively thinner than that of the supporting portion 321, and has a plurality of penetrating openings 325.

In FIG. 1, one mesh portion 322 is formed at every crossing region of the first and second electrodes 12 and 32, but an embodiment is not limited thereto. For example, one mesh portion 322 may overlap a plurality of crossing areas. In this case, the second electrode 32 can be easily manufactured, and can be more easily arranged on the first substrate 11. On the other hand, as shown in FIG. 1, when one mesh portion 322 is formed at each crossing area, a voltage drop of the second electrode 32 can be suppressed by reducing line resistance of the second electrode 32 during a driven state.

In addition, the second electrode 32 is formed of a metal plate having an average thickness that is larger than that of the first electrode 12. For example, the second electrode 32 can be manufactured by cutting out the metal plate in a stripe pattern and then forming a mesh portion 322 that has a step difference with respect to the supporting portion 321 while having the openings 325 by partially eliminating the metal plate through etching. In more detail, the mesh portion 322 may be formed through a double etching process or a double-sided etching process.

The second electrode 32 may be formed of a nickel-iron alloy or other suitable metal materials. The second electrode 32 is manufactured through a separate process to that of the first electrode 12 and the electron emission region 15, and is then adhesively fixed to an inner surface of the first substrate 11 along a direction that crosses the first electrode 12. In this case, as the mesh portion 322 is arranged to dispose the second electrode 32 on the first electrode 12 and the electron emission region 15, insulation between the first and second electrodes 12 and 32 can be automatically secured.

In addition, one crossing region of the first and second electrodes 12 and 32 may be located in one pixel area of the light emitting device 101, or two or more crossing areas may be located in one pixel area of the light emitting device 101. In the latter case, the first electrodes 12 and the second electrodes 32 that correspond to one pixel area are electrically connected to each other and are applied with the same voltage.

The second substrate assembly 20 includes a second substrate (e.g., a front substrate) 21, a third electrode 22, a phosphor layer 25, and a reflective layer 28. The third electrode 22, the phosphor layer 25, and the reflective layer 28 are sequentially formed on an inner surface of the second substrate 21 and disposed to oppose the first substrate assembly 10. That is, the third electrode 22, the phosphor layer 25, and the reflective layer 28 are arranged close to the second substrate 21 in an order of the third electrode 22, the phosphor layer 25, and the reflective layer 28. Here, in one embodiment, the third electrode 22 is an anode electrode.

The third electrode 22 is formed of a transparent conductive material such as indium tin oxide (ITO) so that visible light emitted from the phosphor layer 25 can transmit therethrough. The third electrode 22 is an acceleration electrode that receives a high voltage (i.e., anode voltage) of thousands of volts or more to place the phosphor layer 25 at a high potential state so as to attract an electron beam.

The phosphor layer 25 may be formed of a mixture of red, green, and blue phosphors, which can collectively emit white light. FIG. 1 and FIG. 2 illustrate a case where the phosphor layer 25 is formed on the entire active area of the second substrate 21, but an embodiment is not limited thereto. That is, the phosphor layer 25 may be divided into a plurality of sections corresponding to the pixel areas.

The reflective layer 28 may be an aluminum layer having a thickness of several thousands of angstroms (Å), and has fine holes formed therein for transmitting an electron beam. The reflective layer 28 functions to enhance the luminance of the light emitting device 101 by reflecting visible light emitted from the phosphor layer 25 to the first substrate assembly 10 toward the first substrate assembly 10.

Either the third electrode 22 or the reflective layer 28 can be omitted. When the third electrode 22 is omitted, the reflective layer 28 can be applied with the anode voltage and perform the same function as the third electrode 22.

In addition, although it is not shown, the light emitting device 101 may further include a spacer interposed between the first and second substrates 10 and 20 that withstands a compression force to uniformly maintain a gap between the first and second substrates 10 and 20.

According to the above-described configuration, an electric field is formed around the electron emission region 15 in pixels having a voltage difference between the first electrode 12 and the second electrode 32 of greater than a threshold voltage so that electrons are emitted therefrom. The emitted electrons are attracted by the anode voltage applied to the third electrode 22 and collide with a corresponding portion of the phosphor layer 25, thereby exciting the corresponding phosphor layer. Luminance of the phosphor layer 25 for each pixel corresponds to an electron beam emission amount of the corresponding pixel.

As shown in FIG. 2, since the mesh portion 322 of the second electrode 32 is located above the electron emission region 15, the electrons emitted from the electron emission region 15 pass through the openings 325 of the mesh portion 322 and reach the phosphor layer 25 with minimal beam diffusion. Accordingly, the light emitting device 101 according to the exemplary embodiment can effectively suppress charging of the wide walls of the light emitting device 101 by reducing the initial diffusion angle of an electron beam.

As a result, the light emitting device 101 of this exemplary embodiment can stabilize driving by increasing withstand voltage characteristics of the first electrode 10 and the second electrode 32, and can achieve high luminance by applying a voltage of 10 kV or more, and, in one embodiment, between about 10 and about 15 kV, to the third electrode 22.

In addition, a manufacturing process of the light emitting device 101 according to exemplary embodiment can be simplified because a conventional thick film process for forming an insulation layer and a thin film process for forming the second electrode 32 can be omitted.

Also, the light emitting device 101 can be simply formed by sequentially forming the first electrode 12 and the electron emission region 15 on the flat first substrate 11, arranging the second electrode 32 to dispose the mesh portion 322 on the first electrode 12 and the electron emission region 15, and then adhesively fixing the second electrode 32 to the first substrate 11. Further, the first and second electrodes 12 and 32 can be insulated from each other through the above process.

Moreover, since the second electrode 32 is disposed after the electron emission region 15 is formed, a conventional problem that the first and second electrodes 12 and 32 are short circuited with each other due to the electrical coupling of a conductive electron emission material between the first and second electrodes 12 and 32 during a process for forming the electron emission region 15 can be reduced or eliminated.

In addition, the mesh portion 322 and the supporting portion 321 are integrally formed, and the mesh portion 322 is stably supported by the supporting portion 321 of which the thickness is larger than that of the mesh portion 322. In addition, the entire thickness of the second electrode 32 is relatively large. Accordingly, the second electrode 32 can be stably fixed onto the first substrate 11, and oscillation of the mesh portion 322 due to a driving frequency can be suppressed, thereby reducing or preventing noise generation. Also, the height of the opening 325 of the mesh portion 322 is fixed to a constant level so that uniformity of luminance can be enhanced.

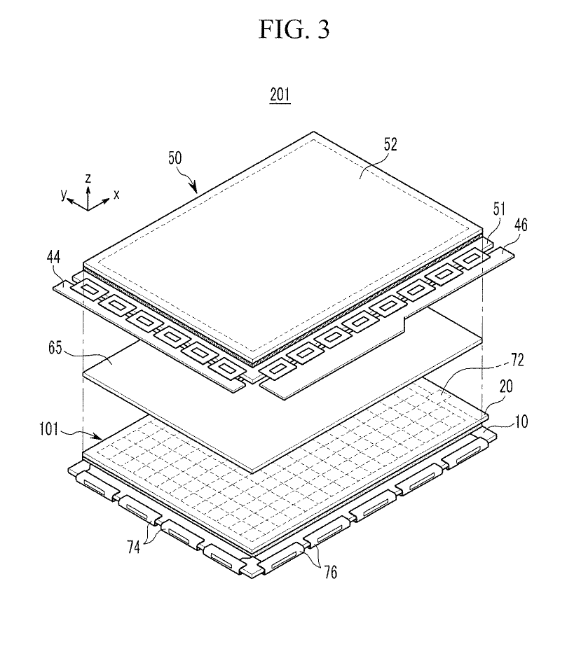

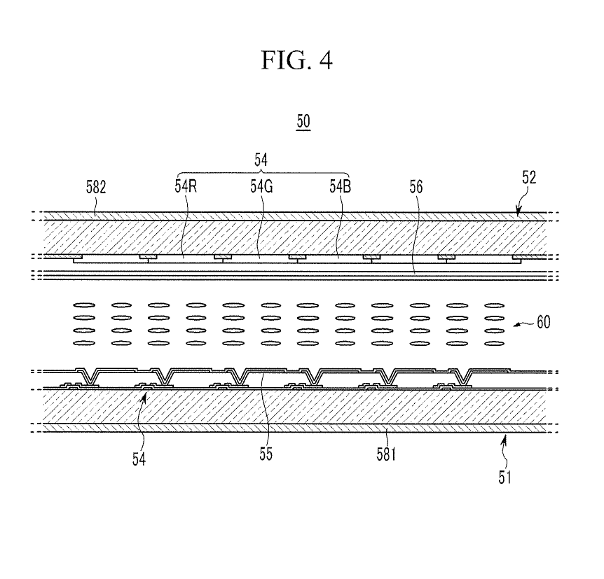

Hereinafter, a display device 201 according to an exemplary embodiment will be described in more detail with reference to FIG. 3 and FIG. 4. The display device 201 includes the light emitting device 101 of FIG. 1.

As shown in FIG. 3, the display device 201 includes the light emitting device 101 and a display panel 50 disposed in front of the light emitting device 101. In addition, the display device 201 may further include a diffusion member 65 that is disposed between the light emitting device 101 and the display panel 50 to evenly diffuse light emitted to the light emitting device 101. In this case, the diffusion member 65 and the light emitting device 101 have a set or predetermined distance therebetween. The display device 201 includes the light emitting device 101 according to an exemplary embodiment as a light source.

In FIG. 3, a liquid crystal display panel is used as the display panel 50, but the present invention is not limited thereto. Therefore, the display panel 50 may be a passive display panel other than the liquid crystal display panel.

As shown in FIG. 4, the display panel 50 includes a first display plate 51 on which a thin film transistor (TFT) 54 and a pixel electrode 55 are formed, a second display plate 52 on which a color filter layer 54 and a common electrode 56 are formed, and a liquid crystal layer 60 inserted between the first display plate 51 and the second display plate 52. Polarizing plates 581 and 582 are attached to a front surface of the first display plate 51 and a rear surface of the second display plate 52 to polarize light passing through the display panel 50.

A pixel electrode 55 is provided to each sub-pixel, and is controlled by the TFT 54. Here, a plurality of sub-pixels that respectively realize different colors form one pixel, and the pixel is the smallest unit for displaying an image. The pixel electrodes 55 and the common electrode 56 are formed of a transparent conductive material. The color filter 54 includes a red filter layer 54R, a green filter layer 54G, and a blue filter layer 54B provided to correspond to respective sub-pixels.

When the thin film transistor 54 of a specific sub-pixel is turned on, an electric field is formed between the pixel electrode 55 and the common electrode 56. The electric field varies the arrangement angle of liquid crystal molecules of the liquid crystal layer 60, and the light transmittance is varied in accordance with the varied arrangement angle. The display panel 50 can control the luminance and color for each pixel by this process.

In addition, a structure of the display panel 50 is not limited to the above-described structure, and can be variously modified to well-known structures that can be easily practiced by a person skilled in the art.

In addition, the display device 201, as shown in FIG. 3, includes a gate circuit board 44 that supplies a gate driving signal to a gate electrode of each TFT 54 of the display panel 50, and a data circuit board 46 that supplies a data driving signal to a source electrode of each TFT 54 of the display panel 50.

The light emitting device 101 includes a number of pixels that is less than the number of pixels of the display panel 50, so that one pixel of the light emitting device 101 corresponds to two or more pixels of the display panel 50.

Each pixel of the light emitting device 101 may emit light in response to gray levels of the corresponding pixels of the display panel 50. In one example, each pixel of the light emitting device 101 may emit light in response to the highest gray level of the gray levels of corresponding pixels of the display panel 50. Each pixel of the light emitting device 101 can represent gray levels in grayscales of 2 bits to 8 bits.

Hereinafter, for better understanding and ease of description, a pixel of the display panel 50 is referred to as a first pixel, a pixel of the light emitting device 101 is referred to as a second pixel, and first pixels corresponding to one second pixel are referred to as a first pixel group.

A driving operation of the light emitting device 101 may be as follows: a signal controller for controlling the display panel 50 detects a highest gray level of the gray levels of the first pixels in the first pixel group; a gray level required for light emission of the second pixel depending on the detected gray level is calculated, and then converted to digital data; a driving signal of the light emitting device 101 is generated by using the digital data; and the generated driving signal is applied to the driving electrodes of the light emitting device 101.

The driving signal of the light emitting device 101 includes a scan signal and a data signal. One of the first electrode 12 and the second electrode 32 receives the scan signal, and the other one receives the data signal.

In addition, a data circuit board and a scan circuit board for driving the light emitting device 101 may be disposed at the rear surface of the light emitting device 101. The data circuit board and the scan circuit board are respectively connected to the first electrode 12 and the second electrode 32 through a first connector 76 and a second connector 74. A third connector 72 applies an anode voltage to the third electrode 22.

When an image is displayed at the first pixel group, the second pixel of the light emitting device 101 emits light of a certain or predetermined gray level synchronously with the first pixel group. That is, the light emitting device 101 provides light of a high luminance to a bright area in the image displayed by the display panel 50, and provides light of a low luminance to a dark area therein. Therefore, with the display device 201 according to an exemplary embodiment, a contrast ratio may be increased and image quality may be sharpened.

With the above-described configuration, the display device 201 can have the light emitting device 101 having enhanced productivity by using a stably simplified structure and simplifying a manufacturing process.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emitting device comprising:
a first substrate;
a first electrode in a stripe pattern extending along a first direction and on the first substrate;
an electron emission region on the first electrode; and
a second electrode in a stripe pattern extending along a second direction crossing the first direction of the first electrode,
wherein the second electrode comprises a supporting portion adhered to the first substrate and a mesh portion having a surface facing the first electrode, the surface of the mesh portion being recessed away from the first electrode and the electron emission region.

2. The light emitting device of claim 1, wherein the mesh portion comprises a plurality of openings for transmitting an electron beam emitted from the electron emission region.

3. The light emitting device of claim 2, further comprising:
a second substrate opposing the first substrate; and
a third electrode and a phosphor layer on a surface of the second substrate and between the first substrate and the second substrate.

4. The light emitting device of claim 2, wherein the second electrode is composed of a metal plate having a greater average thickness than that of the first electrode.

5. The light emitting device of claim 4, wherein the mesh portion is formed through a double etching process or a double-sided etching process.

6. A display device comprising:
a light emitting device comprising:
a first substrate;
a first electrode in a stripe pattern extending along a first direction and on the first substrate;
an electron emission region on the first electrode; and
a second electrode in a stripe pattern extending along a second direction crossing the first direction of the first electrode,
wherein the second electrode comprises a supporting portion adhered to the first substrate and a mesh portion having a surface facing the first electrode, the surface of the mesh portion being recessed away from the first electrode and the electron emission region; and
a display panel configured to receive light from the light emitting device and to display an image.

7. The display device of claim 1, wherein the mesh portion comprises a plurality of openings for transmitting an electron beam emitted from the electron emission region.

8. The display device of claim 7, further comprising:
a second substrate opposing the first substrate; and
a third electrode and a phosphor layer on a surface of the second substrate and between the first substrate and the second substrate.

9. The display device of claim 7, wherein the second electrode is composed of a metal plate having a greater average thickness than that of the first electrode.

10. The light emitting device of claim 9, wherein the mesh portion is formed through a double etching process or a double-sided etching process.

11. A method for forming a light emitting device, the method comprising:
forming a first electrode in a stripe pattern extending along a first direction and on a substrate;
forming an electron emission region on the first electrode; and
forming a second electrode in a stripe pattern extending along a second direction crossing the first direction of the first electrode,
wherein the second electrode is formed to comprise a supporting portion adhered to the first substrate and a mesh portion having a surface facing the first electrode, the surface of the mesh portion being recessed away from the first electrode and the electron emission region.

12. The method of claim 11, wherein the mesh portion is formed through a double etching process or a double-sided etching process.
